(19) United States
(12) Patent Application Publication
(10) Pub. No.: US 2025/0274021 A1
(43) Pub. Date: Aug. 28, 2025

(54) MOTOR-DRIVEN COMPRESSOR

(71) Applicant: KABUSHIKI KAISHA TOYOTA JIDOSHOKKI, Aichi-ken (JP)

(72) Inventors: Yoshifumi TADA, Kariya-shi (JP); Katsuya USAMI, Kariya-shi (JP); Atsushi OSHIMA, Kariya-shi (JP); Kenta MATSUOKA, Kariya-shi (JP)

(73) Assignee: KABUSHIKI KAISHA TOYOTA JIDOSHOKKI, Aichi-ken (JP)

(21) Appl. No.: 19/055,812

(22) Filed: Feb. 18, 2025

(30) Foreign Application Priority Data
Feb. 28, 2024 (JP) 2024-028331

(51) Int. Cl. H02K 11/33; H02K 21/12

(52) U.S. Cl. CPC H02K 11/33; H02K 21/12; F25B 2600/021; H02K 2211/03

(57) ABSTRACT

An inverter of a motor-driven compressor includes a circuit board on which an electronic component is mounted. The housing includes a motor housing member that defines a suction chamber, an inverter housing member that defines an inverter accommodating chamber, and a partition wall that separates the suction chamber and the inverter accommodating chamber from each other. The electronic component includes a main body that acts to remove noise. The circuit board faces the partition wall. The main body faces an outer peripheral surface of the motor housing member in a radial direction of the rotary shaft. A projected area of the main body onto the circuit board in the axial direction is smaller than a projected area of the main body onto the outer peripheral surface of the motor housing member in the radial direction.

### CROSS-REFERENCE TO RELATED APPLICATIONS

This application is based upon and claims the benefit of priority from Japanese Patent Application No. 2024-028331, filed on Feb. 28, 2024, the entire contents of which are incorporated herein by reference.

### BACKGROUND

### 1. Field

The present disclosure relates to a motor-driven compressor.

### 2. Description of Related Art

For example, International Publication No. 2020/090701 discloses a motor-driven compressor that includes a compression mechanism, an electric motor, an inverter controller, and a housing. The housing includes a compressor housing member that accommodates the compression mechanism, a motor housing member that accommodates the electric motor, an inverter housing member that accommodates the inverter controller, and a cover connected to the inverter housing member.

The inverter housing member includes a tubular side wall and a partition wall that closes the rear side of the side wall. The cover closes a space defined by the side wall and the partition wall. An inverter chamber, which accommodates the inverter controller, is defined in the space defined by the side wall, the partition wall, and the cover.

In the motor-driven compressor disclosed in the above publication, each of the inverter housing member and the cover includes a projecting portion that projects radially outward from the outer peripheral surface of the motor housing member, in a side view of the motor housing member as seen in the axial direction. These projecting portions expand the inverter chamber.

In the motor-driven compressor disclosed in the above publication, a portion including the projecting portion of the inverter housing member and the projecting portion of the cover may vibrate. Such vibration of the projecting portion of the inverter housing member and the projecting portion of the cover may generate noise.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a motor-driven compressor includes a rotary shaft, a motor configured to rotate the rotary shaft, a compression unit configured to compress a fluid by rotation of the rotary shaft, an inverter configured to drive the motor, and a housing that accommodates the rotary shaft, the compression unit, the motor, and the inverter. The inverter includes a circuit board on which a drive element configured to drive the motor and an electronic component configured to remove noise are mounted. The housing includes a motor housing member that accommodates the motor and defines a suction chamber configured to draw in the fluid, a compression unit housing member that accommodates the compression unit and is configured to discharge the compressed fluid, an inverter housing member that defines an inverter accommodation chamber that accommodates the inverter, and a partition wall that separates the suction chamber and the inverter accommodating chamber from each other. The electronic component includes a main body that acts to remove noise, and a connection portion that electrically connects the main body and the circuit board to each other. The inverter accommodation chamber includes a first accommodation space in which the circuit board is disposed to face the partition wall, and a second accommodation space that opens in an axial direction of the rotary shaft and is arranged such that the main body faces an outer peripheral surface of the motor housing member in a radial direction of the rotary shaft. A projected area of the main body onto the circuit board in the axial direction is smaller than a projected area of the main body onto the outer peripheral surface of the motor housing member in the radial direction.

Other features and aspects will be apparent from the following detailed description, the drawings, and the claims.

### BRIEF DESCRIPTION OF THE DRAWINGS

FIG. 1 is a partially cut away diagram showing a motor-driven compressor according to an embodiment.

FIG. 2 is a cross-sectional view illustrating part of the motor-driven compressor shown in FIG. 1.

FIG. 3 is a perspective view of the housing body and the inverter shown in FIG. 2.

FIG. 4 is a perspective view of the magnetic component shown in FIG. 3.

FIG. 5 is an explanatory cross-sectional view illustrating operation of the motor-driven compressor shown in FIG. 1.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

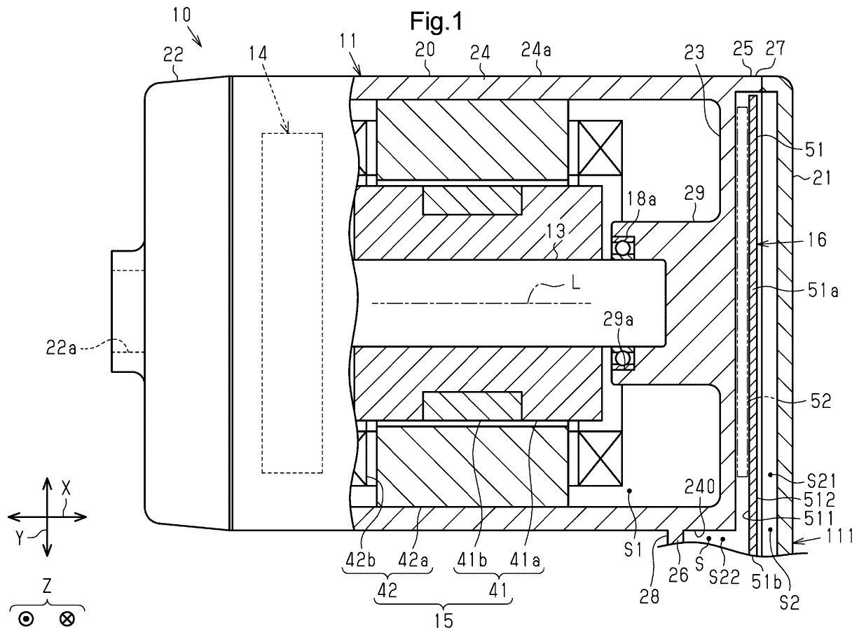

A motor-driven compressor 10 according to an embodiment will now be described with reference to FIGS. 1 to 5. The motor-driven compressor 10 of the present embodiment is used in a vehicle air conditioner.

As shown in FIG. 1, the motor-driven compressor 10 includes a housing 11, a rotary shaft 13, a compression unit 14, a motor 15, and an inverter 16. The housing 11 accommodates the rotary shaft 13, the compression unit 14, the motor 15, and the inverter 16. The motor 15 rotates the rotary shaft 13. The compression unit 14 is driven by rotation of the rotary shaft 13 to compress a refrigerant, which is a fluid. The inverter 16 drives the motor 15.

### Housing

The housing 11 includes a housing body 20, a first cover 21, and a second cover 22. Each of the housing body 20, the first cover 21, and the second cover 22 is made of metal. For example, each of the housing body 20, the first cover 21, and the second cover 22 is made of aluminum.

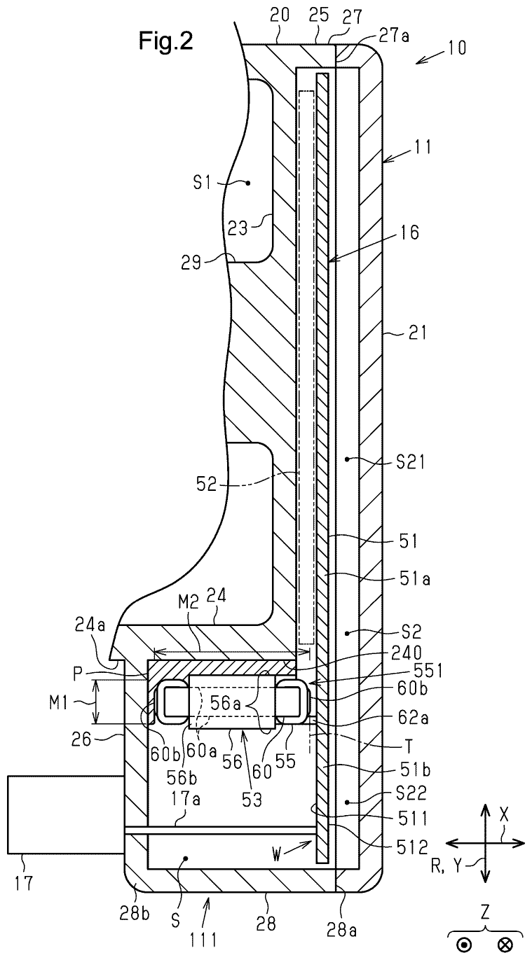

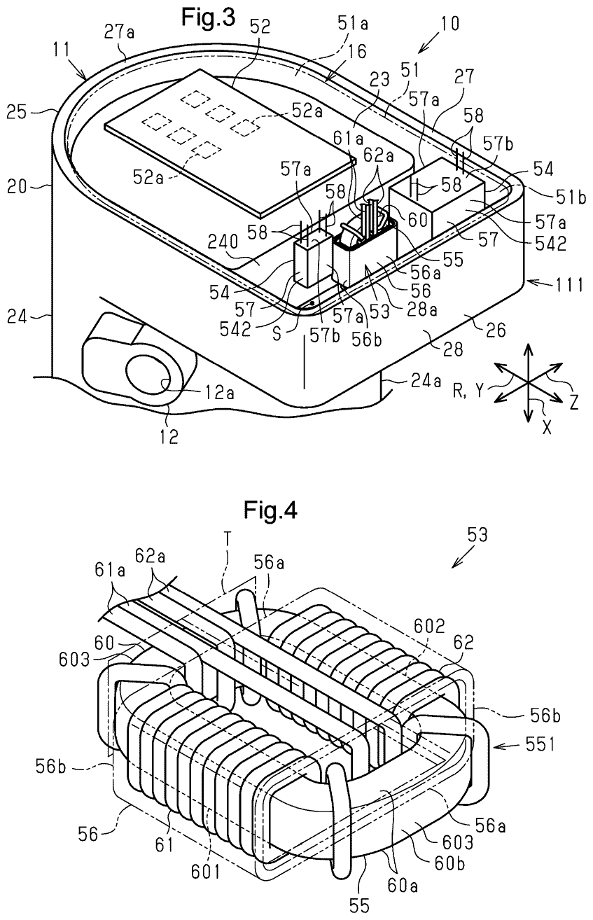

As shown in FIGS. 2 and 3, the housing body 20 includes a plate-shaped partition wall 23, a tubular motor housing member 24, and a tubular inverter housing member 25. The motor housing member 24 extends in a tubular shape from an outer peripheral portion of the partition wall 23 in the thickness direction of the partition wall 23. The inverter housing member 25 extends from a part of the outer peripheral portion of the partition wall 23 in a direction opposite to the direction in which the motor housing member 24 extends.

As shown in FIG. 1, the direction in which a central axis L of the rotary shaft 13 extends is defined as an axial direction X. The axial direction of the motor housing member 24 agrees with the axial direction X of the rotary shaft 13 and also agrees with the thickness direction of the partition wall 23. Accordingly, the tubular motor housing member 24 extends in the axial direction X of the rotary shaft 13.

As shown in FIG. 3, the motor housing member 24 includes a passage forming portion 12. The passage forming portion 12 protrudes from an outer peripheral surface 24a of the motor housing member 24. The passage forming portion 12 is disposed between a central portion of the motor housing member 24 and the partition wall 23 in the axial direction of the motor housing member 24. A suction passage 12a is defined in the passage forming portion 12. The suction passage 12a is connected to a first end of an external refrigerant circuit (not shown). As shown in FIG. 1, the motor housing member 24 and the partition wall 23 define a suction chamber S1.

As shown in FIG. 3, the outer shape of the inverter housing member 25 is larger than the outer shape of the motor housing member 24. The inverter housing member 25 includes a base 27, which is continuous with the outer edge of the partition wall 23, and an extension 28, which is not continuous with the partition wall 23. The extension 28 is located outward of an outer peripheral surface 24a of the motor housing member 24 in a first direction Y, which is orthogonal to the axial direction X. The first direction Y agrees with one of radial directions R of the rotary shaft 13. In a side view of the motor housing member 24 as seen in the axial direction X, the extension 28 protrudes outward from the outer peripheral surface 24a of the motor housing member 24. In other words, the extension 28 protrudes outward beyond the outer peripheral surface 24a of the motor housing member 24 in a radial direction R of the rotary shaft 13.

As shown in FIG. 2, unlike the base 27, the extension 28 extends in the axial direction X from the partition wall 23 on the same side as the motor housing member 24. Accordingly, the dimension of the extension 28 in the axial direction X is larger than the dimension of the base 27 in the axial direction X. The extension 28 includes a first end 28a and a second end 28b. Each of the first end 28a and the second end 28b is an end of the extension 28 in the axial direction X. The first end 28a of the extension 28 is located at the same position as a distal end 27a of the base 27 in the axial direction X. The second end 28b of the extension 28 is located on the opposite side of the partition wall 23 from the first end 28a in the axial direction X. A portion of the extension 28 that extends from the partition wall 23 on the same side as the motor housing member 24 in the axial direction X is located on the outer periphery of the motor housing member 24.

The extension 28 includes a closing wall 26 that connects the outer peripheral surface 24a of the motor housing member 24 to the second end 28b of the inverter housing member 25. The closing wall 26 is located on the same side in the axial direction X of the partition wall 23 as the motor housing member 24. Specifically, the closing wall 26 is connected to the outer peripheral surface 24a of the motor housing member 24 at a position that is on the same side of the partition wall 23 as the motor housing member 24 in the axial direction X and away from the partition wall 23. Accordingly, a space S is defined inside the extension 28 by the outer peripheral surface 24a of the motor housing member 24, the inner peripheral surface of the extension 28, and the inner surface of the closing wall 26. The space S is defined so as to be recessed in relation to the partition wall 23 in the same direction in which the motor housing member 24 extends. Therefore, the space S is open in the axial direction X of the rotary shaft 13.

A connector 17 is provided on the closing wall 26. The connector 17 extends in the axial direction X from the closing wall 26 on the side opposite to the inverter housing member 25. The connector 17 is electrically connected to a power supply (not shown) mounted on a vehicle (not shown). The connector 17 is electrically connected to a circuit board 51, which will be discussed below, by a wire 17a.

As shown in FIG. 1, the partition wall 23 includes a boss 29. The boss 29 extends in the same direction as the direction in which the motor housing member 24 extends from the partition wall 23. The boss 29 includes a recess 29a. The recess 29a is recessed from a central portion of the distal end face of the boss 29.

The outer shape of the first cover 21 corresponds to the outer shape of the inverter housing member 25. As shown in FIG. 2, the first cover 21 is coupled to the inverter housing member 25. Specifically, the first cover 21 is coupled to the distal end 27a of the base 27 and the first end 28a of the extension 28. The first cover 21 closes the opening of the inverter housing member 25. The first cover 21 also closes an opening formed in the extension 28 of the inverter housing member 25. The extension 28 and a portion of the first cover 21 that closes the opening formed in the extension 28 of the inverter housing member 25 form a projecting wall 111. As described above, in a side view of the motor housing member 24 as seen in the axial direction X, the extension 28 protrudes outward from the outer peripheral surface 24a of the motor housing member 24. Therefore, the housing 11, in a side view of the motor housing member 24 as seen in the axial direction X, includes the projecting wall 111, which extends outward beyond the outer peripheral surface 24a of the motor housing member 24. Hereinafter, in the side view of the motor housing member 24 as seen in the axial direction X, the direction in which the projecting wall 111 extends outward beyond the outer peripheral surface 24a of the motor housing member 24 is defined as the first direction Y. The direction orthogonal to both the axial direction X and the first direction Y is defined as a second direction Z.

The partition wall 23, the extension 28, a portion of the outer peripheral surface 24a of the motor housing member 24, the inner peripheral surface of the inverter housing member 25, and the inner surface of the first cover 21 define an inverter accommodating chamber S2 that accommodates the inverter 16. Accordingly, the inverter housing member 25 defines the inverter accommodating chamber S2. The inverter accommodating chamber S2 is also defined inside the projecting wall 111. The partition wall 23 separates the suction chamber S1 from the inverter accommodating chamber S2 in the axial direction X.

The inverter accommodating chamber S2 includes a first accommodation space S21, which faces the partition wall 23 in the axial direction X, and a second accommodation space S22, which is located outward of the outer peripheral surface 24a of the motor housing member 24 in a side view of the motor housing member 24 as seen in the axial direction X. The second accommodation space S22 is formed by closing the space S defined inside the projecting wall 111 with the first cover 21. Therefore, the second accommodation space S22 is an accommodation space defined inside the projecting wall 111.

The second accommodation space S22 is located alongside the suction chamber S1 in the first direction Y with the motor housing member 24 interposed therebetween. Therefore, the second accommodation space S22 is disposed outward of the outer peripheral surface 24a of the motor housing member 24 in the radial direction R of the rotary shaft 13. In the following description, a section of the outer peripheral surface 24a of the motor housing member 24 that defines the second accommodation space S22 is referred to as a defining surface 240.

As shown in FIG. 1, the second cover 22 is coupled to a distal end of the motor housing member 24. The second cover 22 closes the opening of the motor housing member 24. The second cover 22 includes a discharge port 22a. The discharge port 22a is connected to a second end of the external refrigerant circuit (not shown) opposite to the first end, to which the suction passage 12a is connected.

The motor-driven compressor 10 is mounted on the vehicle in such an orientation that the suction chamber S1 and the first accommodation space S21 of the inverter accommodating chamber S2 are alongside each other in the horizontal direction. However, the mounting orientation of the motor-driven compressor 10 with respect to the vehicle may be changed as necessary. The first accommodation space S21 of the inverter accommodating chamber S2 is located above or below the second accommodation space S22 in the vertical direction.

The rotary shaft 13 is accommodated in the motor housing member 24 of the housing 11. The rotary shaft 13 extends in the axial direction of the motor housing member 24. A first shaft end of the rotary shaft 13 is inserted into the recess 29a of the boss 29. The first shaft end of the rotary shaft 13 is rotatably supported by the boss 29 with a bearing 18a. A second shaft end of the rotary shaft 13, which is located at the side opposite to the first shaft end, is rotatably supported by a shaft support member (not shown).

The compression unit 14 is accommodated in the motor housing member 24 of the housing 11. The compression unit 14 is disposed between the motor 15 and the second cover 22 in the axial direction X. Thus, the motor housing member 24 includes a compression unit housing member that accommodates the compression unit 14.

The motor 15 is accommodated in the suction chamber S1. That is, the suction chamber S1 also acts as a motor accommodating chamber that accommodates the motor 15. Therefore, the motor housing member 24 accommodates the motor 15 and defines the suction chamber S1, into which a fluid is drawn. The motor 15 includes a rotor 41 and a stator 42. The rotor 41 includes a cylindrical rotor core 41a and permanent magnets 41b. The rotor core 41a is fixed to the rotary shaft 13. The permanent magnets 41b are embedded in the rotor core 41a. The permanent magnets 41b are disposed at equal intervals in the circumferential direction of the rotor core 41a. The stator 42 surrounds the rotor 41. The stator 42 has a cylindrical stator core 42a and a motor coil 42b. The stator core 42a is fixed to the inner peripheral surface of the motor housing member 24. The motor coil 42b is wound around the stator core 42a.

When the motor coil 42b is energized, the rotor 41 rotates. The rotary shaft 13 rotates integrally with the rotor 41. When the rotary shaft 13 operates, the compression unit 14 is driven. When the compression unit 14 is driven, refrigerant is drawn into the suction chamber S1 from the external refrigerant circuit through the suction passage 12a. The refrigerant drawn into the suction chamber S1 is compressed by the compression unit 14. The refrigerant compressed by the compression unit 14 is discharged to a discharge chamber (not shown) defined in the motor housing member 24, and is then discharged through the discharge port 22a to the external refrigerant circuit. The compression unit 14 may be a scroll type, a piston type, or a vane type. As described above, the housing 11 includes the motor housing member 24, which accommodates the motor 15 and defines the suction chamber S1 into which the refrigerant is drawn, the compression unit housing member, which accommodates the compression unit 14 and discharges compressed fluid, the inverter housing member 25, which defines the inverter accommodating chamber S2 that accommodates the inverter 16, and the partition wall 23, which separates the suction chamber S1 from the inverter accommodating chamber S2.

### Inverter

As shown in FIGS. 2 and 3, the inverter 16 accommodated in the inverter accommodating chamber S2 includes the circuit board 51, on which an inverter circuit 52 including drive elements 52a for driving the motor 15, a magnetic component 53, and two capacitors 54 are mounted. The magnetic component 53 includes a choke coil 55 and a conductive ring 56. The magnetic component 53 and the capacitors 54 are electronic components that remove noise.

The thickness direction of the circuit board 51 agrees with the axial direction X. The circuit board 51 has a first mounting surface 511 and a second mounting surface 512 located on a side opposite to the first mounting surface 511 in the thickness direction. The outer shape of the circuit board 51 is larger than the outer shape of the motor housing member 24. The circuit board 51 includes a first board portion 51a, which is accommodated in the first accommodation space S21 of the inverter accommodating chamber S2, and a second board portion 51b, which is accommodated in the second accommodation space S22 of the inverter accommodating chamber S2. The first board portion 51a of the circuit board 51 is disposed in the first accommodation space S21 of the inverter accommodating chamber S2 so as to face the partition wall 23. Therefore, the inverter accommodating chamber S2 includes the first accommodation space S21, in which the circuit board 51 is disposed so as to face the partition wall 23.

The second accommodation space S22, in which the second board portion 51b of the circuit board 51 is accommodated, is open in the axial direction X of the rotary shaft 13. The second board portion 51b, which is a part of the circuit board 51, is accommodated in the second accommodation space S22 of the inverter accommodating chamber S2 such that the first mounting surface 511 is orthogonal to the axial direction X of the rotary shaft 13. The first board portion 51a extends across the entirety of the first accommodation space S21 in the first direction Y and across the entirety of the first accommodation space S21 in the second direction Z. The second board portion 51b extends across the entirety of the second accommodation space S22 in the first direction Y and across the entirety of the second accommodation space S22 in the second direction Z. The two capacitors 54 and the magnetic component 53 are accommodated in the second accommodation space S22.

The drive elements 52a of the inverter circuit 52 perform switching operations to drive the motor 15. The drive elements 52a of the inverter circuit 52 are mounted on the first mounting surface 511 of the first board portion 51a of the circuit board 51.

### Magnetic Component

As shown in FIG. 4, the magnetic component 53 includes a choke coil 55 and a conductive ring 56. Hereinafter, the choke coil 55 will be referred to as a magnetic main body 551. The magnetic main body 551 includes a magnetic core 60 formed of a magnetic material, a first coil 61, and a second coil 62. The coils 61, 62 are wound around the magnetic core 60.

The magnetic core 60 has the shape of a stadium or an ellipse. The magnetic core 60 is therefore a component extending in a longitudinal direction. The magnetic core 60 formed of a ferromagnetic material is, for example, a ferrite core. The magnetic core 60 includes a first spool portion 601, a second spool portion 602, and two coupling portions 603. Each of the first spool portion 601 and the second spool portion 602 has the shape of a rectangular parallelepiped. The first spool portion 601 and the second spool portion 602 extend parallel to each other. One of the coupling portions 603 couples one end of the first spool portion 601 in the longitudinal direction to one end of the second spool portion 602 in the longitudinal direction. The other coupling portion 603 couples the other end of the first spool portion 601 in the longitudinal direction to the other end of the second spool portion 602 in the longitudinal direction.

The magnetic core 60 has two core main surfaces 60a. The two core main surfaces 60a are end faces of the magnetic core 60 in the axial direction and opposite surfaces of the magnetic core 60 in the thickness direction. The magnetic core 60 has two core side surfaces 60b. The core side surfaces 60b are formed by the outer surface of the coupling portion 603. Each of the first coil 61 and the second coil 62 includes a winding wound around the coupling portions 603. Each core side surface 60b is a portion of an end face of the magnetic core 60 in the longitudinal direction, and is located between the winding of the first coil 61 and the winding of the second coil 62, which are wound around the coupling portions 603. One of the two core side surfaces 60b faces the circuit board 51, which will be discussed below.

One of the two core side surfaces 60b connects ends on the same side of the two core main surfaces 60a to each other. The other core side surface 60b connects the ends on the opposite side of the two core main surfaces 60a to each other. The surface area of each core side surface 60b is smaller than the surface area of each core main surface 60a.

The first coil 61 is wound around the first spool portion 601 of the magnetic core 60. The two ends of the first coil 61 are two first lead wires 61a, which are drawn out from the magnetic core 60. The second coil 62 is wound around the second spool portion 602 of the magnetic core 60. The two ends of the second coil 62 are two second lead wires 62a, which are drawn out from the magnetic core 60. Each of the two first lead wires 61a and the two second lead wires 62a is drawn out along the core main surface 60a of one of the coupling portions 603, and protrudes outward beyond the core side surface 60b of that coupling portion 603.

As shown in FIG. 2, in the magnetic main body 551, the dimension in the thickness direction of the magnetic core 60 including the first coil 61 and the second coil 62 is defined as a first dimension M1. In the magnetic main body 551, the dimension of the core main surface 60a in the longitudinal direction is defined as a second dimension M2. The first dimension M1 is smaller than the second dimension M2. Accordingly, the magnetic main body 551 is a component extending in the longitudinal direction.

A virtual surface T is established along one of the core side surfaces 60b. The virtual plane T is a plane including the core side surface 60b and is orthogonal to the longitudinal direction of the magnetic core 60. Each of the first lead wires 61a and the second lead wires 62a extends linearly from the virtual plane T. The first lead wires 61a and the second lead wires 62a extend from the virtual plane T so as to overlap with one of the core side surfaces 60b in the axial direction X.

As indicated by the long-dash double-short-dash lines in FIG. 4, the conductive ring 56 has the shape of a loop. The conductive ring 56 is made of a conductive material. The conductive ring 56 is made of, for example, copper or aluminum. The conductive ring 56 includes two first plate portions 56a and two second plate portions 56b.

Each of the two first plate portions 56a and the two second plate portions 56b has the shape of a rectangular flat plate. The two first plate portions 56a face each other with the magnetic core 60, the first coil 61, and the second coil 62 interposed therebetween. One of the two first plate portions 56a connects the respective ends of the two second plate portions 56b to each other. The other first plate portion 56a connects the opposite ends of the two second plate portions 56b to each other. The two second plate portions 56b face each other. The direction in which the two first plate portions 56a face each other and the direction in which the two second plate portions 56b face each other are orthogonal to each other.

Part of the magnetic main body 551 is disposed inside the conductive ring 56. The axial direction of the magnetic core 60 and the axial direction of the conductive ring 56 are orthogonal to each other. The axial direction of the magnetic core 60 agrees with the first direction Y. The axial direction of the conductive ring 56 agrees with the axial direction X. The first spool portion 601 and the second spool portion 602 of the magnetic core 60, a portion of the first coil 61 that is wound around the first spool portion 601, and a portion of the second coil 62 that is wound around the second spool portion 602 are located inside the conductive ring 56. The two first plate portions 56a of the conductive ring 56 are disposed so as to sandwich the magnetic main body 551 in the axial direction of the magnetic core 60. The two second plate portions 56b of the conductive ring 56 are disposed so as to sandwich the magnetic main body 551 in the direction in which the first coil 61 and the second coil 62 are arranged.

When a normal mode current flows through the first coil 61 the second coil 62, magnetic flux leaks from the magnetic core 60. Accordingly, induced current flows in the conductive ring 56 to generate magnetic flux resisting changes in the leakage magnetic flux leaking from the magnetic core 60. The induced current flowing through the conductive ring 56 is converted into thermal energy, so that normal mode noise is reduced. The magnetic component 53 is therefore an electronic component that removes noise. The magnetic component 53 includes the magnetic main body 551, which acts to remove noise.

As shown in FIG. 2, the magnetic component 53 is mounted on the first mounting surface 511 of the second board portion 51b of the circuit board 51. The magnetic main body 551 of the magnetic component 53 is disposed in the second accommodation space S22 so as to face the outer peripheral surface 24a of the motor housing member 24. Therefore, the inverter accommodating chamber S2 includes the second accommodation space S22, which is arranged such that the magnetic main body 551 faces the outer peripheral surface 24a of the motor housing member 24 in the radial direction R of the rotary shaft 13.

Each of the two first lead wires 61a and the two second lead wires 62a of the magnetic main body 551 is electrically connected to the circuit board 51. Therefore, each of the two first lead wires 61a and the two second lead wires 62a is a connection portion that electrically connects the magnetic main body 551 to the circuit board 51. A portion of each of the two first lead wires 61a and the two second lead wires 62a that extends outward beyond the core side surface 60b included in the virtual plane T is connected to the circuit board 51 without being bent.

The magnetic component 53 is mounted on the second board portion 51b of the circuit board 51 and is accommodated in the second accommodation space S22. In other words, the magnetic main body 551 of the magnetic component 53 is disposed inside the projecting wall 111. The axial direction of the magnetic core 60 is orthogonal to the axial direction X and agrees with the first direction Y. The magnetic main body 551 is disposed inside the projecting wall 111 such that the thickness direction of the magnetic core 60 is orthogonal to the axial direction X. One of the two core main surfaces 60a faces the defining surface 240, which is the outer peripheral surface 24a of the motor housing member 24.

One of the two first plate portions 56a of the conductive ring 56 is located between the motor housing member 24 and the magnetic main body 551.

The two core side surfaces 60b of the magnetic core 60 includes one core side surface 60b that is included in the virtual plane T, from which the first lead wires 61a and the second lead wires 62a extend, and faces the first mounting surface 511 of the second board portion 51b of the circuit board 51.

### Capacitors

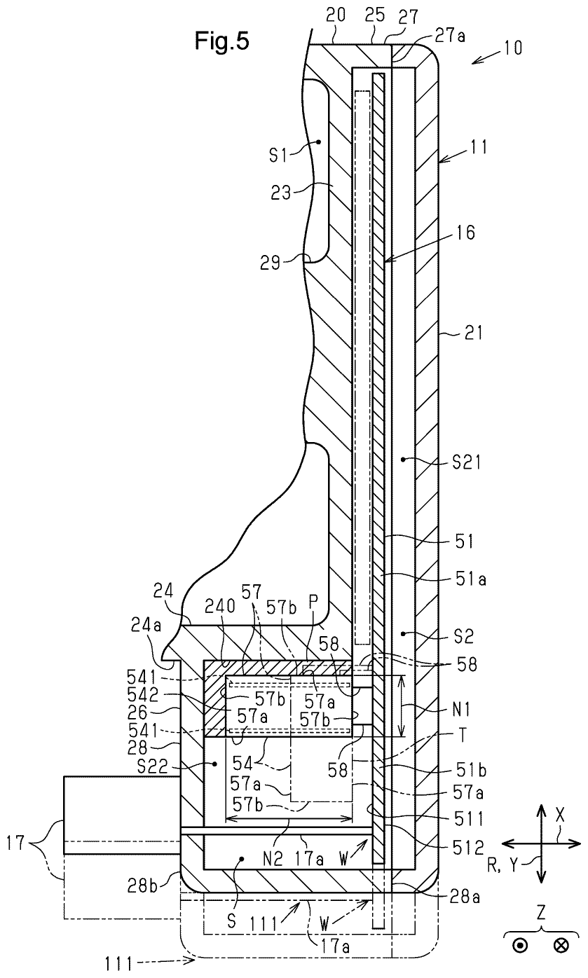

As shown in FIGS. 3 and 5, each capacitor 54, which is an electronic component, includes a capacitor main body 57 and lead wires 58. The capacitor main body 57 of each capacitor 54 is a main body that removes noise. The capacitor main body 57 includes two electrodes 541 and a case 542 that accommodate the two electrodes 541. The capacitor main body 57 has the shape of a rectangular parallelepiped. The capacitor main body 57 includes two capacitor main surfaces 57a. The capacitor main surfaces 57a are the largest of the six outer surfaces of the capacitor main body 57. A direction orthogonal to the two capacitor main surfaces 57a is defined as a thickness direction of the capacitor main body 57. The capacitor main body 57 includes two capacitor end faces 57b. The two capacitor end faces 57b are outer surfaces that have the smallest areas among the six outer surfaces of the capacitor main body 57 and are continuous with the opposite ends of the capacitor main surfaces 57a in the longitudinal direction. The dimension N1 of each capacitor end face 57b in the thickness direction of the capacitor main body 57 is smaller than the dimension N2 of each capacitor main surface 57a in the longitudinal direction.

The multiple lead wires 58 extend straight from one of the two capacitor end faces 57b. The two capacitor end faces 57b of each capacitor main body 57 include one capacitor end face 57b that is included in the virtual plane T, from which the lead wires 58 extend, and faces the first mounting surface 511 of the second board portion 51b of the circuit board 51.

The capacitors 54 are mounted on the second board portion 51b of the circuit board 51. Specifically, each capacitor 54 is mounted on the circuit board 51 such that the capacitor end face 57b from which the lead wires 58 extend faces the first mounting surface 511 of the second board portion 51b.

Each capacitor 54 is mounted on the circuit board 51 such that the longitudinal direction of the capacitor main surface 57a is orthogonal to the first mounting surface 511 of the circuit board 51. In other words, each capacitor 54 is mounted on the circuit board 51 such that the longitudinal direction of the capacitor main surface 57a agrees with the axial direction X of the motor housing member 24. The thickness direction of the capacitor main body 57 agrees with the first direction Y. Therefore, the thickness direction of the capacitor main body 57 is orthogonal to the axial direction X of the motor housing member 24. Thus, each capacitor 54 is disposed inside the projecting wall 111 such that the thickness direction of the capacitor main body 57 is orthogonal to the axial direction X. One of the two capacitor main surfaces 57a faces the defining surface 240 of the outer peripheral surface 24a of the motor housing member 24. Therefore, each capacitor 54 is accommodated in the second accommodation space S22. Thus, the inverter accommodating chamber S2 includes the second accommodation space S22, which is arranged such that each capacitor main body 57 faces the outer peripheral surface 24a of the motor housing member 24 in the radial direction R of the rotary shaft 13.

As shown in FIG. 3, the two capacitors 54 are arranged at the opposite sides of the magnetic component 53 in the second direction Z. In other words, the magnetic component 53 is located between the two capacitors 54 in the second direction Z. Therefore, the two capacitors 54 and the magnetic component 53 are arranged alongside one another in the second direction Z inside the projecting wall 111. That is, the two capacitors 54 and the magnetic component 53 are arranged alongside one another in the second direction Z at the same position in the first direction Y.

As shown in FIGS. 2 and 5, the connector 17 and the wire 17a are disposed at positions farther from the motor housing member 24 than the two capacitors 54 and the magnetic component 53 in the first direction Y. In other words, the two capacitors 54 and the magnetic component 53 are disposed at positions closer to the motor housing member 24 than the connector 17 and the wire 17a in the first direction Y.

Potting material P, which is a heat transfer member, is provided between the outer peripheral surface 24a of the motor housing member 24 and the group of the magnetic main body 551, the conductive ring 56, and the capacitors 54. The potting material P may be provided between the closing wall 26 and the core side surface 60b of the magnetic main body 551, from which the first lead wires 61a or the second lead wires 62a are not drawn out, and between the closing wall 26 and the capacitor end face 57b of each capacitor 54, from which the lead wires 58 are not drawn out.

### Operation of the Present Embodiment

Operation of the present embodiment will now be described.

In FIG. 5, a comparative example is indicated by long-dash double-short-dash lines. In the comparative example, the capacitors 54 are disposed such that the lead wires 58 are bent and one of the capacitor main surfaces 57a faces the first mounting surface 511 of the second board portion 51b. In this case, the projected area of each capacitor main body 57 onto the circuit board 51 in the axial direction X of the rotary shaft 13 is the same as the size of the capacitor main surface 57a. The projected area of each capacitor main body 57 onto the outer peripheral surface 24a of the motor housing member 24 in the radial direction R of the rotary shaft 13 is the same as the size of the capacitor end face 57b. Therefore, the projected area of each capacitor main body 57 onto the circuit board 51 in the axial direction X is larger than the projected area of the capacitor main body 57 onto the outer peripheral surface 24a of the motor housing member 24 in the radial direction R.

As indicated by the solid lines in FIG. 5, in the present embodiment, the capacitors 54 are disposed such that the lead wires 58 extend straight without being bent, and one of the capacitor end faces 57b faces the first mounting surface 511 of the second board portion 51b. In this case, the projected area of each capacitor main body 57 onto the circuit board 51 in the axial direction X of the rotary shaft 13 is the same as the size of the capacitor end face 57b. The projected area of each capacitor main body 57 onto the outer peripheral surface 24a of the motor housing member 24 in the radial direction R of the rotary shaft 13 is the same as the size of the capacitor main surface 57a. Therefore, the projected area of each capacitor main body 57 onto the circuit board 51 in the axial direction X is smaller than the projected area of the capacitor main body 57 onto the outer peripheral surface 24a of the motor housing member 24 in the radial direction R.

The lead wires 58 are disposed so as to overlap with the capacitor end faces 57b in the axial direction X of the rotary shaft 13. Thus, the lead wires 58 extend such that the projected area of each capacitor main body 57 onto the circuit board 51 in the axial direction X is smaller than the projected area of the capacitor main body 57 onto the outer peripheral surface 24a of the motor housing member 24 in the radial direction R of the rotary shaft 13.

In the present embodiment, as indicated by the solid lines in FIG. 2, the first lead wires 61a and the second lead wires 62a of the magnetic component 53 extend straight without being bent. The magnetic main body 551 is disposed such that one of the core side surfaces 60b of the magnetic core 60 faces the first mounting surface 511 of the second board portion 51b. In this case, the projected area of the magnetic main body 551 onto the circuit board 51 in the axial direction X of the rotary shaft 13 is substantially the same as the size of the core side surface 60b. The projected area of the magnetic main body 551 onto the outer peripheral surface 24a of the motor housing member 24 in the radial direction R of the rotary shaft 13 is substantially the same as the size of each core main surface 60a. Therefore, the projected area of the magnetic main body 551 onto the circuit board 51 in the axial direction X is smaller than the projected area of the magnetic main body 551 onto the outer peripheral surface 24a of the motor housing member 24 in the radial direction R.

The first lead wires 61a and the second lead wires 62a are disposed so as to overlap with the core side surface 60b in the axial direction X of the rotary shaft 13. Thus, the first lead wires 61a and the second lead wires 62a extend such that the projected area of the magnetic main body 551 onto the circuit board 51 in the axial direction X is smaller than the projected area of the magnetic main body 551 onto the outer peripheral surface 24a of the motor housing member 24 in the radial direction R of the rotary shaft 13.

The connector 17 and the wire 17a are disposed at positions farther from the motor housing member 24 than the two capacitors 54 and the magnetic component 53 in the first direction Y. Specifically, the second board portion 51b accommodated in the inverter accommodating chamber S2 includes a region W, on which the connector 17 is disposed via the wire 17a, which connects the connector 17 to the circuit board 51. The region W is located in a portion outward of the capacitors 54 and the magnetic component 53 in the first direction Y. In the comparative example, if the area W is located in a portion of the second board portion 51b that is outward of the capacitors 54 and the magnetic component 53 in the first direction Y, the connector 17 and the wire 17a are located farther from the motor housing member 24 in the first direction Y than in the case of the embodiment, as indicated by the long-dash double-short-dash lines in FIG. 5. In contrast, in the present embodiment, the area on the second board portion 51b of the circuit board 51 on which the capacitors 54 and the magnetic component 53 are located is smaller than that in the comparative example. As a result, even if the region W for disposing the connector 17 via the wire 17a, which connects the connector 17 to the circuit board 51, is provided on the second board portion 51b, the dimension of the second board portion 51b in the first direction Y is smaller than that in the comparative example. Consequently, the dimension in the first direction Y of the projecting wall 111, which accommodates the second board portion 51b, is also smaller than that in the comparative example.

### Advantages of the Present Embodiment

The present embodiment has the following advantages.
(1) The capacitors 54 are disposed in the second accommodation space S22 in the inverter housing member 25 and are mounted on the circuit board 51 such that the projected area of each capacitor main body 57 onto the second board portion 51b in the axial direction X is smaller than the projected area of the capacitor main body 57 onto the outer peripheral surface 24a of the motor housing member 24 in the radial direction R. In other words, the longitudinal direction of each capacitor main body 57 extends in the axial direction X. As a result, when the housing 11 is seen in the axial direction X, the configuration reduces the dimension in the radial direction R of the rotary shaft 13 of the portion of the inverter housing member 25 that defines the second accommodation space S22. Consequently, the inverter housing member 25 suppresses vibration of the portion that defines the second accommodation space S22, thereby suppressing the generation of noise due to such vibration.
(2) The magnetic component 53 is disposed in the second accommodation space S22 in the inverter housing member 25 and is mounted on the circuit board 51 such that the projected area of the magnetic main body 551 onto the second board portion 51b in the axial direction X is smaller than the projected area of the magnetic main body 551 onto the outer peripheral surface 24a of the motor housing member 24 in the radial direction R. In other words, the longitudinal direction of the magnetic main body 551 extends in the axial direction X. As a result, when the housing 11 is seen in the axial direction X, the configuration reduces the dimension in the radial direction R of the rotary shaft 13 of the portion of the inverter housing member 25 that defines the second accommodation space S22. Consequently, the inverter housing member 25 suppresses vibration of the portion that defines the second accommodation space S22, thereby suppressing the generation of noise due to such vibration.
(3) The second accommodation space S22 for accommodating the two capacitors 54 and the magnetic component 53 is defined in the inverter housing member 25 of the housing 11. The extension 28, which defines the second accommodation space S22 for accommodating these three components, acts as a rib of the housing 11. This further suppresses the vibration of the portion of the inverter housing member 25 that defines the second accommodation space S22.
(4) The dimension N2 in the longitudinal direction of each capacitor main surface 57a of the capacitor main body 57 of each capacitor 54 is larger than the dimension NI in the thickness direction of each capacitor end face 57b of the capacitor main body 57. The second dimension M2 in the longitudinal direction of the magnetic main body 551 of the magnetic component 53 is larger than the first dimension M1 in the thickness direction of the magnetic core 60. Even though the magnetic component 53 and the capacitors 54, which have such shapes, are disposed in the second accommodation space S22 of the inverter housing member 25, the configuration reduces the size of the portion of the inverter housing member 25 that defines the second accommodation space S22. Therefore, the vibration of the inverter housing member 25 is further suppressed. This configuration thus suppresses the generation of noise caused by vibration of the inverter housing member 25.
(5) The capacitors 54 are disposed such that the thickness direction of each capacitor main body 57 is orthogonal to the axial direction X. The magnetic component 53 is disposed such that the axial direction of the magnetic core 60 in the magnetic main body 551 is orthogonal to the axial direction X. The two capacitors 54 and the magnetic component 53 are arranged alongside one another in the second direction Z. Thus, compared to a configuration in which the two capacitors 54 and the magnetic component 53 are arranged alongside one another in the first direction Y (i.e., the radial direction R), the second board portion 51b for mounting the two capacitors 54 and the magnetic component 53 is made compact in the radial direction R. Therefore, when the housing 11 is seen in the axial direction X, the configuration reduces the dimension in the radial direction R of the rotary shaft 13 of the portion of the inverter housing member 25 that defines the second accommodation space S22. Consequently, the inverter housing member 25 suppresses vibration of the portion that defines the second accommodation space S22, thereby suppressing the generation of noise due to such vibration.
(6) The capacitors 54 are disposed such that the thickness direction of each capacitor main body 57 is orthogonal to the axial direction X. Thus, each capacitor end face 57b faces the circuit board 51, and the lead wires 58 extending from the capacitor end face 57b extend straight. The magnetic component 53 is disposed such that the axial direction of the magnetic core 60 in the magnetic main body 551 is orthogonal to the axial direction X. The first lead wires 61a and the second lead wires 62a of the magnetic component 53 extend straight from the core side surface 60b toward the circuit board 51. Accordingly, the lead wires 58, the first lead wires 61a, and the second lead wires 62a are not bent to be connected to the circuit board 51. Therefore, as compared to a case in which the lead wires 58, the first lead wires 61a, and the second lead wires 62a are provided with bent sections, the number of points on which stresses are concentrated is reduced in the lead wires 58, the first lead wires 61a, and the second lead wires 62a.
(7) The lead wires 58 of each capacitor 54 extend such that the projected area of the capacitor main body 57 onto the circuit board 51 in the axial direction X is smaller than the projected area of the capacitor main body 57 onto the outer peripheral surface 24a of the motor housing member 24 in the radial direction R of the rotary shaft 13. The first lead wires 61a and the second lead wires 62a of the magnetic component 53 extend such that the projected area of the magnetic main body 551 onto the circuit board 51 in the axial direction X is smaller than the projected area of the magnetic main body 551 onto the outer peripheral surface 24a of the motor housing member 24 in the radial direction R of the rotary shaft 13. This reduces the area of a portion of the circuit board 51 on which the capacitors 54 and the magnetic main body 551 are disposed. Accordingly, the dimension of the portion of the inverter housing member 25 that defines the second accommodation space S22 is reduced in the radial direction R of the rotary shaft 13.
(8) The potting material P is provided between the capacitor main bodies 57 and the outer peripheral surface 24a of the motor housing member 24. The potting material P is also provided between the magnetic main body 551 and the outer peripheral surface 24a of the motor housing member 24. The potting material P increases the heat dissipation area of the capacitor main bodies 57 and the magnetic main body 551. Therefore, the capacitor main bodies 57 and the magnetic main body 551 are cooled efficiently.

### Modifications

The above-described embodiment may be modified as described below. The above-described embodiment and the following modifications can be combined as long as the combined modifications remain technically consistent with each other.

The structure of the housing 11 may be changed.

For example, in the above-described embodiment, the partition wall 23, the motor housing member 24, the inverter housing member 25, and the extension 28 are integrally formed as the housing body 20. However, these components do not necessarily need to be integrally formed. Specifically, the motor housing member 24 and the inverter housing member 25 may be formed separately, and the extension 28 may be formed integrally with the motor housing member 24. In this case, when the motor housing member 24 and the inverter housing member 25 are joined to each other, the second accommodation space S22 may be defined by the motor housing member 24 and the inverter housing member 25.

Only one of the electronic components, either the magnetic component 53 or one of the two capacitors 54, may be accommodated in the second accommodation space S22.

Electronic components other than the magnetic component 53 and the two capacitors 54, for example, the drive elements 52a, which form the inverter circuit 52, may be accommodated in the second accommodation space S22.

The magnetic component 53 of the inverter 16 does not necessarily need to include the conductive ring 56.

Among the magnetic component 53 and the two capacitors 54, the magnetic component 53 and one of the capacitors 54 may be arranged alongside each other in the second direction Z, and the other capacitor 54 may be arranged on the outer side in the first direction Y of the capacitor 54 and the magnetic component 53 arranged alongside each other in the second direction Z.

Among the magnetic component 53 and the two capacitors 54, the two capacitors 54 may be arranged alongside each other in the second direction Z, and the magnetic component 53 may be arranged on the outer side in the first direction Y of the two capacitors 54 arranged alongside each other in the second direction Z.

The magnetic component 53 and the two capacitors 54 may all be arranged alongside one another in the first direction Y.

The lead wires 58 may include bent portions as long as the projected area of each capacitor main body 57 onto the second board portion 51b in the axial direction X is smaller than the projected area of the capacitor main body 57 onto the outer peripheral surface 24a of the motor housing member 24 in the radial direction R of the rotary shaft 13. The first lead wires 61a and the second lead wires 62a may have bent portions as long as the projected area of the magnetic main body 551 onto the second board portion 51b in the axial direction X is smaller than the projected area of the magnetic main body 551 onto the outer peripheral surface 24a of the motor housing member 24 in the radial direction R of the rotary shaft 13.

The heat transfer member may be a thermal grease or a thermal sheet, rather than the potting material P.

The motor-driven compressor 10 may also be used for purposes other than a vehicle air conditioner. For example, the motor-driven compressor 10 may be mounted on a fuel cell electric vehicle. The motor-driven compressor 10 uses the compression unit 14 to compress air, which is fluid, supplied to the fuel cell.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A motor-driven compressor, comprising:
a rotary shaft;
a motor configured to rotate the rotary shaft;
a compression unit configured to compress a fluid by rotation of the rotary shaft;
an inverter configured to drive the motor; and
a housing that accommodates the rotary shaft, the compression unit, the motor, and the inverter, wherein
the inverter includes a circuit board on which a drive element configured to drive the motor and an electronic component configured to remove noise are mounted,
the housing includes:
a motor housing member that accommodates the motor and defines a suction chamber configured to draw in the fluid;
a compression unit housing member that accommodates the compression unit and is configured to discharge the compressed fluid;
an inverter housing member that defines an inverter accommodating chamber that accommodates the inverter; and
a partition wall that separates the suction chamber and the inverter accommodating chamber from each other,
the electronic component includes:
a main body that acts to remove noise; and
a connection portion that electrically connects the main body and the circuit board to each other,
the inverter accommodation chamber includes:
a first accommodation space in which the circuit board is disposed to face the partition wall; and
a second accommodation space that opens in an axial direction of the rotary shaft and is arranged such that the main body faces an outer peripheral surface of the motor housing member in a radial direction of the rotary shaft, and
a projected area of the main body onto the circuit board in the axial direction is smaller than a projected area of the main body onto the outer peripheral surface of the motor housing member in the radial direction.

2. The motor-driven compressor according to claim 1, wherein
the electronic component includes a capacitor,
the capacitor is accommodated in the second accommodation space,
the main body is a capacitor main body of the capacitor, the capacitor main body including two electrodes and a case accommodating the two electrodes, and
a projected area of the capacitor main body onto the circuit board in the axial direction is smaller than a projected area of the capacitor main body onto the outer peripheral surface of the motor housing member in the radial direction of the rotary shaft.

3. The motor-driven compressor according to claim 1, wherein
the electronic component includes a magnetic component,
the magnetic component is accommodated in the second accommodation space,
the main body is a magnetic main body of the magnetic component, the magnetic main body including a magnetic core formed of a magnetic material and a coil wound around the magnetic core, and
a projected area of the magnetic main body onto the circuit board in the axial direction is smaller than a projected area of the magnetic main body onto the outer peripheral surface of the motor housing member in the radial direction of the rotary shaft.

4. The motor-driven compressor according to claim 1, wherein
the connection portion is a lead wire, and
the lead wire extends such that a projected area of the main body onto the circuit board in the axial direction is smaller than a projected area of the main body onto the outer peripheral surface of the motor housing member in the radial direction of the rotary shaft.

5. The motor-driven compressor according to claim 1, wherein a heat transfer member is provided between the main body and the outer peripheral surface of the motor housing member.
